(19) United States
(12) Patent Application Publication
(10) Pub. No.: US 2024/0402812 A1
(43) Pub. Date: Dec. 5, 2024

(54) Vibrotactile Actuator Sensing And Control Using Current Measurement

(71) Applicant: Google LLC, Mountain View, CA (US)

(72) Inventors: Artem Dementyev, Boston, MA (US); Pascal Tom Getreuer, San Francisco, CA (US); Dimitri Kanevsky, Ossining, NY (US); Richard Francis Lyon, Los Altos, CA (US)

(21) Appl. No.: 18/691,575

(22) PCT Filed: Sep. 13, 2021
(86) PCT No.: PCT/US2021/050045

§ 371 Date: Mar. 13, 2024

(51) Int. Cl. G06F 3/01; B06B 1/02; G06F 1/16

(52) U.S. Cl. CPC G06F 3/016; B06B 1/0215; G06F 1/163

(57) ABSTRACT

A vibrotactile device including a first actuator channel having a vibrotactile actuator and a resistor with a predetermined resistance positioned at an input of the vibrotactile actuator, a processor configured to output a driving signal for driving the vibrotactile actuator, and a voltage sensor configured to measure a voltage drop across the resistor. A current drawn by the vibrotactile actuator varies according to a load applied to the vibrotactile actuator and passes through the resistor. The processor is configured to receive voltage drop measurement data from the voltage sensor, detect a load applied to the vibrotactile actuator based on the measured voltage drop, and control the driving signal based on the detected load.

### BACKGROUND

Vibrotactile actuators are commonly used in electronic devices and wearable accessories, such as smartphones and watches, to provide haptic feedback. Behavior of the actuator can change as a function of a load applied to the actuator. The load may be influenced by a range of factors, such as contact area between the actuator and a user, a type of tissue or material in contact with the actuator, and an amount of pressure applied to the actuator.

In order to sense a magnitude of the load applied, actuators typically employ back-electromotive-force (back-EMF) sensing. However, back-EMF sensing has the disadvantage of requiring the actuator to be electrically disconnected from surrounding electronics in order to reliably measure the back-EMF. This, in turn, requires additional switches and a multiplexer with a large number of channels to control the connection and disconnection of the back-EMF sensor, which increases the size, weight and number of components of the actuator.

### BRIEF SUMMARY

The present disclosure uses a current-sensing design instead of back-EMF sensing in order to determine the load applied to the actuator.

In one aspect of the present disclosure, a vibrotactile device includes: a first actuator channel including a vibrotactile actuator and a resistor having a predetermined resistance positioned at an input of the vibrotactile actuator, wherein a current drawn by the vibrotactile actuator varies according to a load applied to the vibrotactile actuator; and wherein the current drawn by the vibrotactile actuator passes through the resistor; a processor configured to output a driving signal for driving the vibrotactile actuator; a loading sensor configured to measure a voltage drop across the resistor, wherein the processor is further configured to: receive voltage drop measurement data from the loading sensor; detect a load applied to the vibrotactile actuator based on the measured voltage drop; and control the driving signal based on the detected load.

In some examples, the driving signal may be a pulse width modulated (PWM) signal, and the first actuator channel further may include a low pass filter configured to filter the driving signal and a current amplifier. The loading sensor may include a current amplifier configured to amplify the voltage drop measurement and a low-pass anti-aliasing filter to filter the amplified voltage drop measurement. The processor may include an analog-to-digital converter (ADC) configured to receive the filtered voltage drop measurement. The processor may be configured to detect a peak in the voltage drop measurement data and determine an amount of loading applied to the vibrotactile actuator based on a height of the peak.

In some examples, the device may further include memory configured to store: a type of the vibrotactile actuator included in the first actuator channel, and one or more current-load correspondence mappings, each mapping indicating a relationship between a plurality of current levels and corresponding loads for a given type of vibrotactile actuator. The processor may be configured to detect the load applied to the vibrotactile actuator based on a current-load correspondence mapping associated with the type of the vibrotactile actuator.

In some examples, the device may further include a plurality of actuator channels including the first actuator channel, each actuator channel including a respective vibrotactile actuator and a respective resistor positioned at the input of the corresponding vibrotactile actuator, and a multiplexer including a plurality of inputs connected to the plurality of actuator channels and an output connected to the loading sensor. The processor may be configured to, for each actuator channel: receive voltage drop measurement data; detect a load applied to the vibrotactile actuator of the actuator channel; and control the driving signal output to the actuator channel based on the corresponding detected load. The driving signal may be a PWM signal. The processor may be configured to determine, for each actuator channel, a pulse width of the PWM signal applied to the actuator channel based on an amount of loading indicated by the voltage drop measurement data for the actuator channel. Additionally or alternatively, the processor may be configured to: determine at which ones of the vibrotactile actuators the load is detected; actuate the vibrotactile actuators at which the load is detected; and turn off the vibrotactile actuators at which the load is not detected. Additionally or alternatively, each actuator channel may further include a respective power gating switch configured to control a connection between an input of the actuator channel an output of the processor, and the processor may be configured to control each of the power gating switches to cyclically activate the plurality of actuator channels.

Another aspect of the disclosure is directed to a portable device including a housing and a vibrotactile device as described in any of the embodiments herein. The vibrotactile device may be disposed inside the housing.

In some examples, the portable device may be a handheld device. Each vibrotactile actuator may be disposed on either one of a left side or a right side of the handheld device. The processor may be configured to provide haptic feedback to the left side of the device based on whether the voltage drop measurement data for any of the vibrotactile actuators on the left side of the device indicates a detected load, and to the right side of the device based on whether the voltage drop measurement data for any of the vibrotactile actuators on the right side of the device indicates a detected load.

In some examples, the portable device may further include one or more orientation detection circuits configured to detect an orientation of the handheld device. The processor may be configured to: receive an indication of the orientation of the handheld device from the one or more orientation detection circuits; and in response to the received indication of the orientation of the handheld device, assign at least one vibrotactile actuator to the left of the device and at least one vibrotactile actuator to the right side of the device.

In some examples, the portable device may include a strap that is wearable around a user's wrist. The vibrotactile actuators may be positioned along a length of the strap to circumferentially surround the user's wrist when the strap is worn.

Yet another aspect of the disclosure is directed to a method including: outputting, by a processor, a driving signal for driving a vibrotactile actuator; receiving, by the processor, a voltage measurement indicating a voltage drop over a resistor positioned at an input of the vibrotactile actuator and having a predetermined resistance; calculating, by the processor, an amount of current drawn by the vibrotactile actuator based on the voltage measurement and the predetermined resistance of the resistor; and controlling, by the processor, the driving signal based on the calculated amount of current.

In some examples, the method may further include controlling, by the processor, a connection to each of a plurality of vibrotactile channels. Only one vibrotactile channel may be connected to the processor at a time. In some examples, calculating the amount of current drawn by the vibrotactile actuator may further include determining a peak current level using an asymmetric smoothing filter and calculating the amount of current drawn by the vibrotactile actuator to equal the determined peak current.

In some examples, calculating the amount of current drawn by the vibrotactile actuator may further include determining a mean square current level and calculating the amount of current drawn by the vibrotactile actuator to equal the mean square current level.

In some examples, the method may further include accessing, by the processor, current-load correspondence data indicating a plurality of amounts of current, each amount of current associated with a corresponding applied load, and determining, by the processor, a magnitude of a load applied to the vibrotactile actuator based on the calculated amount of current and the current-load correspondence data. In some examples, the method may further include determining, by the processor, whether the calculated amount of current is greater than or equal to a threshold amount of current, and outputting, by the processor, one or more haptic feedback signals to the vibrotactile actuator in response to the calculated amount of current being greater than or equal to the threshold amount of current.

### BRIEF DESCRIPTION OF THE DRAWINGS

FIG. 1 is a circuit diagram of an example device in accordance with an aspect of the disclosure.

FIG. 2 is a graph illustrating measured current over a duration of time in the device of FIG. 1.

FIG. 3 is a circuit diagram of another example device in accordance with an aspect of the disclosure.

FIG. 4 is a diagram of a handheld device in accordance with an aspect of the disclosure.

FIG. 5 is a diagram of a wearable device in accordance with an aspect of the disclosure.

FIG. 6 is a flow diagram of an example routine in accordance with an aspect of the disclosure.

### DETAILED DESCRIPTION

### Overview

The present disclosure uses a current-sensing design instead of back-EMF sensing in order to determine the load applied to the actuator. The speed of the actuator motor is a function of the amount of current consumed by the motor, whereby a change in the amount of current corresponds to a change in speed. This means that a change in the load on the actuator corresponds to a change in the current. For example, an increase in motor speed may correspond to an increase in current and to an increase in applied load. In order to measure the current, a resistor having a predetermined resistance is included at an input of the actuator. A voltage drop across the resistor is then amplified, low pass filtered and measured at a loading sensor. An amount of current consumed by the actuator may be calculated from the filtered voltage drop across the resistor. The amount of loading at the actuator may then be deduced from the calculated current.

The present disclosure may be implemented in devices having a single actuator or in devices including multiple actuators. For devices with multiple actuators, a load to each actuator may be separately determined by providing a separate resistor for each actuator channel and connecting all of the actuator channels to the loading sensor through a multiplexer. The multiplexer may be configured to cycle through the multiple actuators, thereby connecting one actuator at a time to the loading sensor and measuring the voltage drop of that actuator's resistor before proceeding to the next actuator.

For devices with multiple actuators, the current sensing may be utilized to detect which of the actuators are in contact with a user. This is because the loading at actuators in contact with the user differs from the loading at actuators that are not in contact with the user. The current sensing device may repeatedly cycle through current sensing operations for each of the actuators and determine, based on the sensed currents, which of the actuators are currently being used by the user. This determination can, in turn, be used to conserve energy at the device, such as by actuating only those actuators that are determined to be in contact with the user.

Altogether, the vibrotactile actuator design of the present disclosure provides several benefits over alternative designs using back-EMF sensing. Firstly, back-EMF sensing may not be suitable for some applications, such as applications that require simultaneous load sensing and actuation, such as for providing constant haptic response. Secondly, the current-sensing design requires fewer components, which in turn reduces a cost, size and weight of the sensor, especially for multichannel systems. Reducing sensor size and weight in wearables is especially beneficial, since users may not want to wear large and heavy accessories. Lastly, the current-sensing design can be operated continuously, whereas back-EMF designs can only be operated sporadically due to the need to deactivate and disconnect the back-EMF sensor in order to complete each sensor reading.

### Example Systems

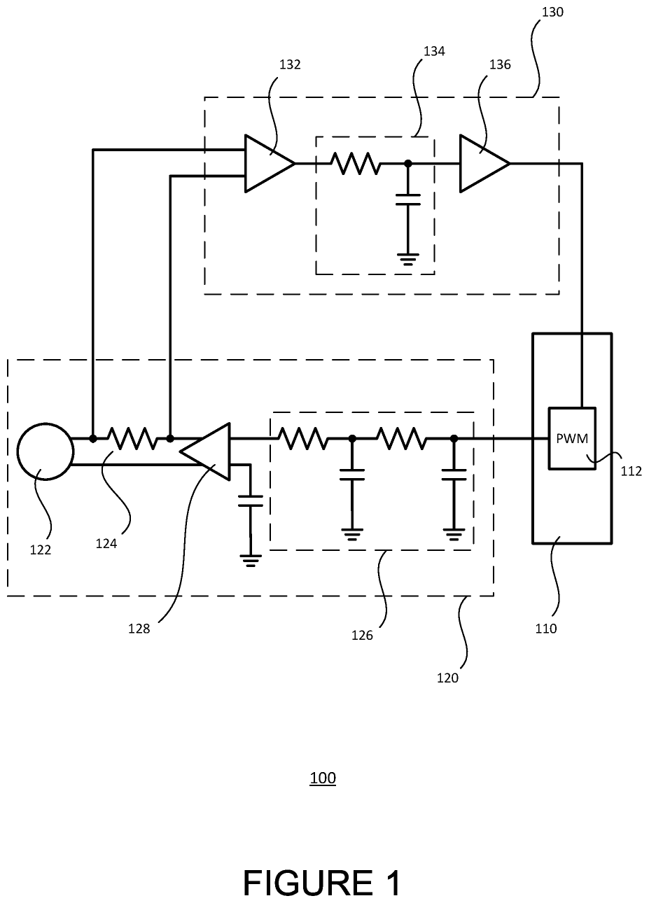

FIG. 1 illustrates a device 100 including a controller 110, an actuator channel 120, and a loading sensor 130.

The controller 110 may be any electronic processor that may process, receive, transmit instructions and operational signals, or any combination thereof, including but not limited to a microprocessor or a microcomputer. The controller 110 may further include or be in communication with a memory device for storing electronic data that may be utilized by the device 100. Such electronic data may include but is not limited to operating system data, instructions, preset data settings, and software applications that may be executed by the processor, such as to provide content to a user of the device 100 such as audio files, document files, calibration information, user settings, and the like. The software applications may further control providing haptic feedback to the user in association with or separate from the provided content. Haptic feedback settings may further be based on the preset data. The memory may include, without limitation, volatile storage, such as random access memory, non-volatile storage, such as read-only memory, flash memory, magnetic storage medium, optical storage medium, erasable programmable memory or any combinations thereof. Additionally, the memory may be embedded in or separate from the controller, may be a removable or non-removable storage device, or any combination thereof.

The actuator channel 120 may include one or more vibrotactile actuators 122. In the example of FIG. 1, only one actuator is shown, although in other arrangements multiple actuators may be provided in a single actuator channel. The actuator 122 may include a housing, a load-sensitive element, and a vibrating element configured to provide haptic feedback in response to a load applied to the load-sensitive element. The example actuators 122 of the present disclosure may be configured to draw a variable amount of current in response to a load applied to the actuator. Example actuators that may be utilized include but are not limited to voice coils, linear resonant actuators (LRA), and linear magnetic rams (LRM). The actuator 122 is configured to receive a driving signal outputted by a signal generator 112 of the controller 110. In the example of FIG. 1, the signal generator is a pulse width modulation (PWM) generator and the driving signal is a PWM signal, whereby a duty cycle of the PWM signal can be adjusting to control a magnitude of vibration provided by vibrating element of the actuator 122, thus providing a haptic effect to a user of the device 100. In other examples, other types of signal generators may be used. For instance, the controller 110 could include a digital-to-analog convertor (DAC) to convert the PWM output into an analog signal, whereby the signal generator 112 may effectively be an analog signal generator.

The actuator channel 120 may further include circuitry for connection to the loading sensor 130 for the purpose of sensing the or load applied to the actuator 122, such as a force applied by the user of the device 100. In the example of FIG. 1, the circuitry may include a resistor 124 connected in series between terminals of a positive output of the signal generator 112 and an input of the actuator 122. Since the amount of current drawn by the actuator varies as a function of the load applied to the actuator 122, the amount of electrical current that flows through the resistor 124 also varies as a function of the load applied to the actuator 122. Since a voltage drop across a resistor is approximately linearly proportional to the current following through the resistor, the load applied to the actuator can be determined based on either one of the voltage drop across the resistor 124 or the current flowing across the resistor 124. The resistor 124 may be sized appropriately to measure the drop in voltage across a maximum current range of the actuator channel 120. For instance, the resistor 124 may have a resistance of about 0.25 ohms.

The actuator channel 120 may further include additional circuitry for enhancing the load sensing across the resistor 124. For example, in FIG. 1, the actuator 120 includes a low pass filter 126 in order to filter artifacts and noise from the driving signal. In the example of FIG. 1, the low pass filer 126 is a second order filter including two RC circuits connected in series between the positive output of the signal generator 112 and the resistor 124. Also in the example of FIG. 1, the actuator channel 120 includes an amplifier 128 for amplifying the driving signal being input to the actuator 122.

The loading sensor 130 may include each of a first and second input connected to opposite sides of the resistor 124. The voltage drop may be derived from a voltage difference between the first and second inputs. The loading sensor 130 may further include additional circuitry for processing the voltage drop, such as a current amplifier 132 for amplifying the sensed current drawn through the resistor based on the voltage difference between the first and second input ports. The current amplifier 132 may be a class-D amplifier having a gain sufficient to permit load sensing across the resistor 124, such as a 20× gain. Also, the current amplifier 132 may have a bandwidth that is relatively high compared to the output of the signal generator 112. For instance, in the case of a PWM signal output of about 540 kHz, the current amplifier 132 may be chosen to have a bandwidth of about 1.8 MHZ.

The loading sensor 130 circuitry may further include a low pass filter 134 to provide a low impedance input to the controller 110. The controller 110 may include an analog-to-digital convertor (ADC) for converting the analog voltage measurement into a digital indication of current drawn by the actuator 122. The ADC samples may have a 10 bit resolution.

The ADC of the controller 110 may sample an output current of the sensor at a frequency that is lower than a frequency of the driving signal, or even one or more orders of magnitude lower than the frequency of the driving signal. For instance, the ADC frequency may be about 10-100 kHz, such as 43.2 kHz. In such circumstances, the low pass filter 134 may further be configured to provide anti-aliasing for the ADC depending on the driving frequency of the controller 110 and the sampling frequency of the ADC. The loading sensor 130 may further include an amplification stage 136 between the anti-aliasing filter 134 and an input of the ADC.

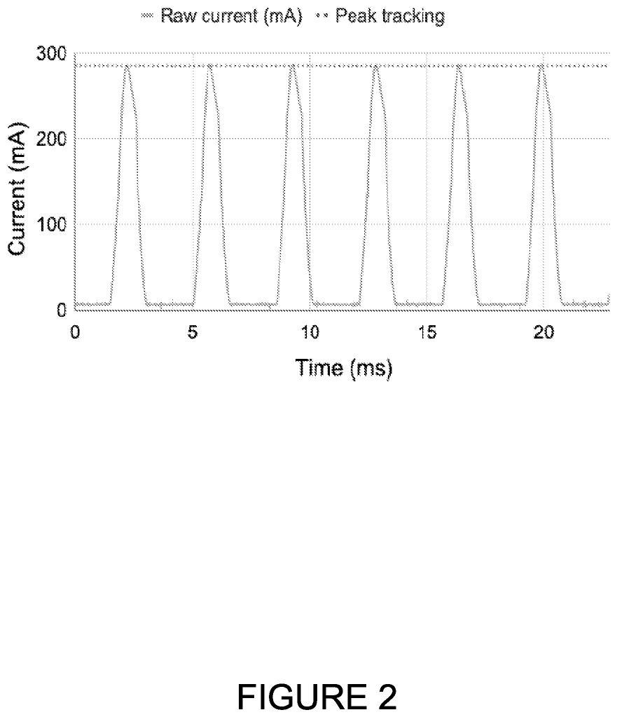

In operation, the device 100 may sample current measurements across the resistor 124 in order to detect changes in loading at the actuator 122. FIG. 2 is a graph illustrating changes in detected current across the resistor over a duration of time. As can be seen from FIG. 2, the changes in detected current may be captured from the running actuator with a sine-wave waveform. Further, since the negative current swings are not detected at the resistor, the waveform is half-wave rectified. A magnitude of the half-wave rectified current spikes may correlate to a magnitude of the load being applied to the actuator. In other words, since a higher load causes the actuator to draw more current, it can be expected can an amount of current flowing across the resistor will correspondingly change.

Detecting a magnitude of the current spikes may involve the controller 110 using a peak detection algorithm. One example peak detection algorithm may involve tracking values associated with current magnitude for each obtained sample and detecting a transition between rise and fall based on the tracked values. In other examples, instead of detecting a maximum current value, a mean square value of current may be detected, whereby a magnitude of the current may be inferred from the mean square value. Alternative known methods may be used for determining current magnitude. In any such method, the amount of loading on the actuator may be correlated to the detected magnitude of the current.

The example device of FIG. 1 includes only a single vibrotactile channel. However, in other devices, it may be desired to sense loading at different locations of the device and to differentiate between the sensed loadings at the different locations. In such instances, the device may be provided with multiple actuators provided in multiple actuator channels, and the controller and loading sensor may be connected to multiple actuator channels in order to independently monitor loading at the multiple actuators. A single controller and single loading sensor may be utilized to monitor the multiple actuator channel, such as in a round-robin fashion.

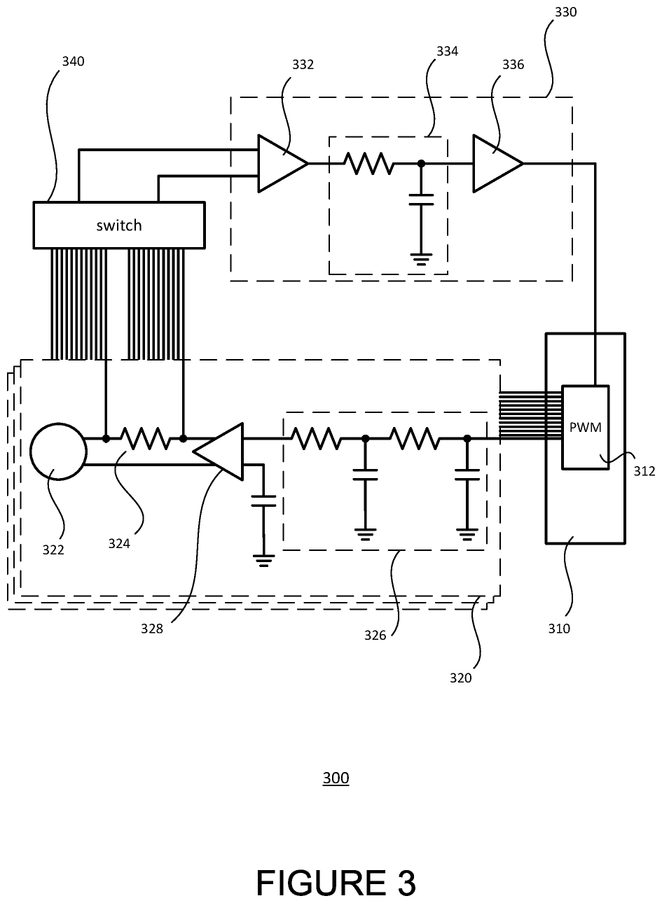

FIG. 3 is a block diagram of an example device 300 including a controller 310, a plurality of actuator channels 320, and a loading sensor 330. Like in the example controller 110 of FIG. 1, the example controller 310 of FIG. 3 includes a driving signal generator 312, which may be a PWM generator, having an output or multiple outputs connected to each of the actuator channels 320. The driving generator block 312 shown in FIG. 3 may represent separate driving signals generators, whereby each separate generator may be configured to generate a separate driving signal to be provided to a different respective actuator channel.

Like in the example actuator channel 120 of FIG. 1, each separate actuator channel 320 of FIG. 3 may include a respective actuator 322, resistor 324, filter 326 and amplifier 328. The components of the actuator channels 320 of FIG. 3 may be arranged according to the same or similar principles as describe in connection with FIG. 1. Since each actuator channel is evaluated separately, the actuators 322 included in the different actuator channels may be different types of actuators. Additionally or alternatively, resistor values, filter values and amplifier characteristics may vary from channel to channel depending on the type of actuator being used, the setting or environment of the actuator being used, or combination thereof. For instance, different actuators may have different driving frequency ranges, different driving amplitudes, or both, and thus may be driven differently. Driving frequency and amplitude ranges and values may be predetermined during manufacture, and the memory of the controller 310 may be programmed with settings for each of the actuators 322 according to the predetermined ranges and values.

The loading sensor 330 of FIG. 3 may be comparable to the loading sensor 110 of FIG. 1. For example, the loading sensor 330 includes each of a current amplifier 332 for amplifying the sensed current of one of the actuator channels 322 at a time, a first order filter 334 for filtering the amplified current signal, and an additional amplifier 336 for amplifying the filtered signal. The output of the loading sensor 330 may be fed to the controller 310 in order to provide feedback from each actuator channel 320 and drive the channels using the signal generator 312 based on the feedback.

Additionally, the device 300 of FIG. 3 includes one or more switches 340 for electrically connecting the different actuator channels 320 to the loading sensor 330. The number of type of switches provided may depend on the number of actuator channels included in the device. In the example of FIG. 3, 12 actuator channels are provided, as indicated by the 12 separate lines connecting an output of the controller 310 to the respective inputs of the actuator channels 320. In such an arrangement, a single multiplexer with at least two outputs and at least twice as many inputs as there are actuator channels may be used, since each channel is connected at two terminals. Alternatively, multiple multiplexers may be used. The multiple multiplexers may each include at least two outputs, and may collectively include at least twice as many inputs as there are actuator channels. Alternatively, if care is taken to connect the same corresponding terminal of each channel to one group of multiplexers and the other corresponding terminal of each channel to a second group of multiplexers, each multiplexers may have as few as one output. Two possible arrangements for the example switch 340 of FIG. 3 may involve providing one 32:2 multiplexer or two 16:2 multiplexers.

In operation, the one or more switches 340 may cycle through the actuator channels 320 one by one, connecting one actuator channel to the loading sensor at a time. Power gating switches may further be provided to completely shut down the loading sensor when not in use, such as between current sensing operations during switching between actuator channels. This may be done in arrangements including the current amplifier 336, since the current amplifier has a quiescent current, for example between about 0.5 to 1.2 mA.

Timing of the switches 340 may be restricted by an amount of time that the low pass filter 334 needs to settle when switching to a new channel. In this regard, the switches may be programmed to switch between channel no more frequently than the settling time of the low pass filter 334 in order to obtain reliable current measurements at each of the channels. In one example arrangement, the settling time was found to be about 500 ms.

Additionally, the current detection algorithm performed at the controller may involve a smoothing algorithm for separating the detected current from other noise in the circuit. In some examples, an asymmetric smoothing filter may be applied to the sampled current values. For instance, a current detection algorithm that detects current peaks and determines their magnitudes may operate according to the following equations:

$${K}_{a t t a c k} = 1 - {e}^{- 1 / {c}_{attack} {f}_{s}} \qquad ( 1 )$$

$${K}_{decay} = 1 - {e}^{- 1 / {c}_{decay} {f}_{s}} \qquad ( 2 )$$

$$K = \{ \begin{matrix}{K}_{a t t a c k} if {I}_{analog} \geq {I}_{p e a k} [ n ] \\ {K}_{d e c a y} if {I}_{analog} < {I}_{p e a k} [ n ]\end{matrix} \qquad ( 3 )$$

$${I}_{p e a k} [ n ] = {I}_{p e a k} [ n - 1 ] + K \cdot ( {I}_{a n a l o g} - {I}_{p e a k} [ n - 1 ] ) \qquad ( 4 )$$

in which [n] is the current iteration of the algorithm, I_{analog} is the sampled current, C_{attack} and C_{decay} are predetermined fixed values corresponding to attack and decay constants that may be set according to the frequency range of actuator, and f_{S} is the sampling frequency[.

The example devices 100, 300 of FIGS. 1 and 3 may be included within another device such as a handheld or wearable device. The actuators of the devices 100, 300 may be used to collect data based on the sensed loads applied to the actuators, and at least in some cases to provide haptic feedback to a user in response to the sensed load.

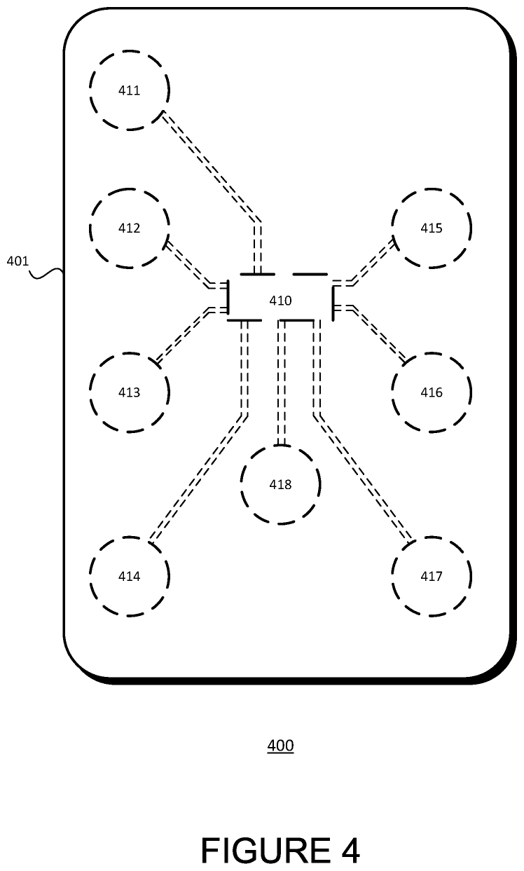

In one example application, shown in FIG. 4, a handheld device 400 including but not limited a mobile phone, tablet, or laptop, includes multiple actuators 411-418 housed within a housing 401 of the device 400. Each of the actuators 411-418 may be electrically connected to a common control circuit 410, which may be comparable to the control circuits 110 or 310 of FIGS. 1 and 3, respectively. Each of the actuators 411-418 may be positioned on a separate actuator channel, whereby the control circuit 410 may obtain current measurements from each of the actuators one after another.

In some examples, the actuators 411-418 may be positioned against an inner surface of the housing 401 in order to provide haptic feedback. In some examples, the actuators 411-418 may be strategically positioned at locations that users' fingers or palms typically positioned. For instance, the actuators 411-418 may be positioned on a back of the device housing 401, since a user's fingers are typically positioned at the back of the device 400. For further instance, the actuators 411-418 may be primarily positioned along sides of the back of the device housing 401 since the user's fingers would typically be positioned there.

In operation, current sensing may be used to determine which to of the actuators the loading from the user's fingers is being applied. For instance, the controller 410 may access a threshold value and compare the sensed current to the threshold value. A sensed current at or above the threshold value may indicate the presence of loading, which in turn may indicate the presence of the user's fingers. Different threshold values may be stored and accessed for different types of actuators. The sensed current information can be used to determine which of the actuators to activate, thereby causing only the activated actuators to vibrate. Such a feature can be used to conserve energy at the device, since actuators that are not in contact with or close to the user's fingers may be kept inactive.

In some applications, the actuators 411-418 may further be divided between halves of the handheld device 400, whereby only actuators on one half of the device are actuated together. For instance, the handheld device may include a controller—either the same as or separate from controller 410—for determining an orientation of the device 400, such as one or more accelerometers, gyroscopes, or both. If it is determined the device is being held in a landscape orientation, then left and right sides of the device may be actuated separately. For instance, using the example arrangement of FIG. 4, if the user's fingers are detected on or close to each of actuators 411, 414, 416, 417 and 418, then the device 400 may determine to provide right-side haptic feedback to only actuator 411 and to provide left-side haptic feedback to each of actuators 414, 416, 417 and 418, and to avoid activating actuators 412, 413, 414 and 415 to conserve energy since the user would not feel the haptic feedback from those actuators anyhow.

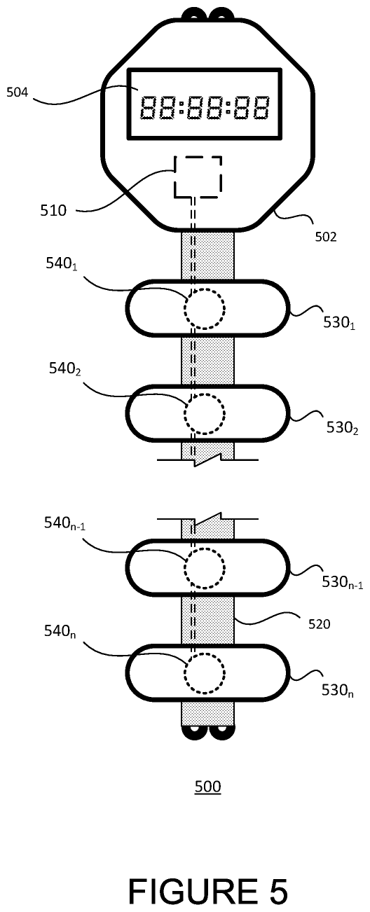

In another example application, shown in FIG. 5, a wearable device 500 such as a smartwatch includes a housing 502 optionally containing a display 504 and further containing a controller 510, which may be comparable to the control circuits 110 or 310 of FIGS. 1 and 3, respectively. The wearable device 500 may further include a band 520 for wearing the device around a user's wrist or arm, and a plurality of links 530₁-530ₙ positioned along a length of the band 520. In some examples, the links 530₁-530ₙ may make up a majority or entirety of the band 520. At least some of the links may include an actuator 540₁-540ₙ which may be embedded within its respective link 530₁-530ₙ. One or more electrical connections between the actuators 540₁-540ₙ and the controller 510 may be provided along the band 520 in order to electrically connect the actuators 540₁-540ₙ to the controller 510. The actuators 540₁-540ₙ may operate in a similar manner as those described in the handheld device, whereby current sensing may be performed at each actuator one at a time, and haptic feedback can be provided to all actuators 540₁-540ₙ or at least those actuators to which loading is applied by the user.

### EXAMPLE METHODS

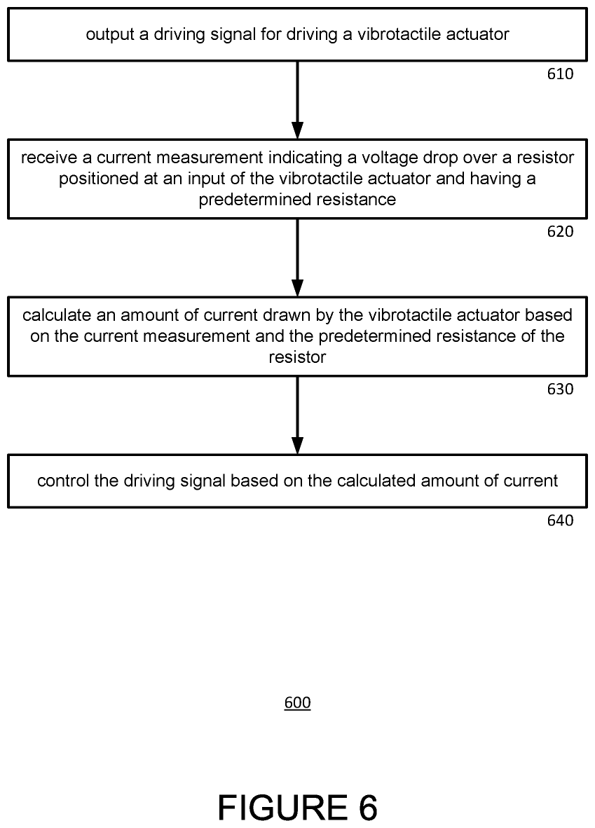

FIG. 6 is a flow diagram of an example routine 600 in accordance with an embodiment of the present disclosure. The routine may be performed by one or more processors included in a controller of the example embodiments herein. It should be understood that steps of the routine may be modified or performed simultaneously or in a different order in accordance with the example of the disclosure herein. Additionally or alternatively, some steps of the routine may be removed, and other steps may be added.

At block 610, the one or more processors may output a driving signal for driving a vibrotactile actuator. In some examples, the driving signal may be a pulse modulation signal for driving the actuator.

At block 620, the one or more processors may receive a current measurement indicating a voltage drop over a resistor positioned at an input of the vibrotactile actuator and having a predetermined resistance. The voltage drop may be measured by an analog sensor and converted to a digital current sample in order to be inputted to the one or more processors. In some examples, the current measurement may further involve a filtering step in order to provide a low impedance input to the ADC of a controller including the one or more processors. Additionally, the current measurement may include a plurality of samples. The plurality of samples may be obtained for a predetermined duration of time after measurements begin to be collected from the actuator, such as at least a settling time of a filter included in the analog sensor.

At block 630, the one or more processors may calculate an amount of current drawn by the vibrotactile actuator based on the current measurement and the predetermined resistance of the resistor. Since the resistor has a predetermined resistance, a magnitude of the current flowing across the resistor may be derived from a voltage drop between ends of the resistor. Also, the amount of current flowing through the resistor may equal the current drawn by the actuator. Since current drawn by the actuator is a function of the loading applied to the actuator, the calculated amount of current can be used to detect loading at the actuator, and in some instances an amount of loading at the actuator.

The calculated amount of current may be a magnitude of a current peak, a mean square of the measured current, or another measure of current over the duration of time for which the current samples are collected.

At block 640, the one or more processors may control the driving signal used to drive the actuator based on the calculated amount of current. For instance, in the case of a PWM module generating the driving signal, a duty cycle of the driving signal may be increased in response to an increase in the calculated amount of current, and may be decreased in response to a decrease in the calculated amount of current.

The routine 600 of FIG. 6 may be performed for a device having multiple actuator channels. In such an example, the one or more processors may continuously output driving signals to each of the actuators, while the current measurements may be received from each actuator channel in a round-robin fashion, one after another. In this regard, the steps of blocks 620-640 may be cyclically repeated for each actuator channel. A rate of cycling through the actuator channels may be limited by the settling time of the filter in the loading sensor, since the sensor cannot switch to the next channel until a reliable measurement at the current channel has been obtained.

The example routine 600 may be applied to actuators included in various devices such as handheld devices and wearables, including but not limited to smartphones and smartwatches.

The example devices and routines described herein have several advantages over prior haptic feedback systems that rely on back-EMF. Firstly, the actuators of the present disclosure do not need to be disconnected from the controller in order to reliably sense loading. Secondly, the current sensing approach requires less space and fewer components that back-EMF sensing, which in turn can reduce time and cost for device production. Lastly, current sensing may be compatible with some applications for which back-EMF sensing is not possible or not practical. Thus, the circuits arrangements and operational techniques described herein yield improvements in device cost, device size, and simplification of device operability.

Although the technology herein has been described with reference to particular embodiments, it is to be understood that these embodiments are merely illustrative of the principles and applications of the present technology. For example, although some embodiments described herein discuss parameters of an “app,” it is merely illustrative and it should be recognized that the same principles may be applied to other programs used by multiple users even if such a program is not generally considered to be an “app.” It is therefore to be understood that numerous modifications may be made to the illustrative embodiments and that other arrangements may be devised without departing from the spirit and scope of the present technology as defined by the appended claims.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A vibrotactile device comprising:
a first actuator channel including a vibrotactile actuator and a resistor having a predetermined resistance positioned at an input of the vibrotactile actuator, wherein a current drawn by the vibrotactile actuator varies according to a load applied to the vibrotactile actuator; and wherein the current drawn by the vibrotactile actuator passes through the resistor;
a processor configured to output a driving signal for driving the vibrotactile actuator;
a loading sensor configured to measure a voltage drop across the resistor, wherein the processor is further configured to:
receive voltage drop measurement data from the loading sensor;
detect a load applied to the vibrotactile actuator based on the measured voltage drop; and
control the driving signal based on the detected load.

2. The vibrotactile device of claim 1, wherein the driving signal is a pulse width modulated (PWM) signal, and wherein the first actuator channel further includes a low pass filter configured to filter the driving signal and a current amplifier.

3. The vibrotactile device of claim 2, wherein the loading sensor includes a current amplifier configured to amplify the voltage drop measurement and a low-pass anti-aliasing filter to filter the amplified voltage drop measurement, and wherein the processor includes an analog-to-digital converter (ADC) configured to receive the filtered voltage drop measurement.

4. The vibrotactile device of claim 3, wherein the processor is configured to detect a peak in the voltage drop measurement data and determine an amount of loading applied to the vibrotactile actuator based on a height of the peak.

5. The vibrotactile device of claim 1, further comprising a memory configured to store:
a type of the vibrotactile actuator included in the first actuator channel; and
one or more current-load correspondence mappings, each mapping indicating a relationship between a plurality of current levels and corresponding loads for a given type of vibrotactile actuator,
wherein the processor is configured to detect the load applied to the vibrotactile actuator based on a current-load correspondence mapping associated with the type of the vibrotactile actuator.

6. A portable device comprising:
a housing; and
the vibrotactile device of claim 1, wherein the vibrotactile device is disposed inside the housing.

7. The vibrotactile device of claim 1, further comprising:
a plurality of actuator channels including the first actuator channel, each actuator channel including a respective vibrotactile actuator and a respective resistor positioned at the input of the corresponding vibrotactile actuator; and
a multiplexer including a plurality of inputs connected to the plurality of actuator channels and an output connected to the loading sensor;
wherein the processor is configured to, for each actuator channel:
receive voltage drop measurement data;
detect a load applied to the vibrotactile actuator of the actuator channel; and
control the driving signal output to the actuator channel based on the corresponding detected load.

8. The vibrotactile device of claim 7, wherein the driving signal is a PWM signal, and wherein the processor is configured to determine, for each actuator channel, a pulse width of the PWM signal applied to the actuator channel based on an amount of loading indicated by the voltage drop measurement data for the actuator channel.

9. The vibrotactile device of claim 7, wherein the processor is configured to:
determine at which ones of the vibrotactile actuators the load is detected;
actuate the vibrotactile actuators at which the load is detected; and
turn off the vibrotactile actuators at which the load is not detected.

10. The vibrotactile device of claim 7, wherein each actuator channel further includes a respective power gating switch configured to control a connection between an input of the actuator channel an output of the processor, wherein the processor is configured to control each of the power gating switches to cyclically activate the plurality of actuator channels.

11. A portable device comprising:
a housing; and
the vibrotactile device of claim 7, wherein the vibrotactile device is disposed inside the housing.

12. The portable device of claim 11, wherein the portable device is a handheld device, and wherein each vibrotactile actuator is disposed on either one of a left side or a right side of the handheld device, and wherein the processor is configured to provide haptic feedback to the left side of the device based on whether the voltage drop measurement data for any of the vibrotactile actuators on the left side of the device indicates a detected load, and to the right side of the device based on whether the voltage drop measurement data for any of the vibrotactile actuators on the right side of the device indicates a detected load.

13. The portable device of claim 12, further comprising one or more orientation detection circuits configured to detect an orientation of the handheld device, wherein the processor is configured to:
receive an indication of the orientation of the handheld device from the one or more orientation detection circuits; and
in response to the received indication of the orientation of the handheld device, assign at least one vibrotactile actuator to the left of the device and at least one vibrotactile actuator to the right side of the device.

14. The portable device of claim 11, wherein the portable device includes a strap that is wearable around a user's wrist, and wherein the vibrotactile actuators are positioned along a length of the strap to circumferentially surround the user's wrist when the strap is worn.

15. A method comprising:
outputting, by a processor, a driving signal for driving a vibrotactile actuator;
receiving, by the processor, a voltage measurement indicating a voltage drop over a resistor positioned at an input of the vibrotactile actuator and having a predetermined resistance;
calculating, by the processor, an amount of current drawn by the vibrotactile actuator based on the voltage measurement and the predetermined resistance of the resistor; and
controlling, by the processor, the driving signal based on the calculated amount of current.

16. The method of claim 15, further comprising:
controlling, by the processor, a connection to each of a plurality of vibrotactile channels, wherein only one vibrotactile channel is connected to the processor at a time.

17. The method of claim 16, wherein calculating the amount of current drawn by the vibrotactile actuator further comprises:
determining a peak current level using an asymmetric smoothing filter; and
calculating the amount of current drawn by the vibrotactile actuator to equal the determined peak current.

18. The method of claim 16, wherein calculating the amount of current drawn by the vibrotactile actuator further comprises:
determining a mean square current level; and
calculating the amount of current drawn by the vibrotactile actuator to equal the mean square current level.

19. The method of claim 15, further comprising:
accessing, by the processor, current-load correspondence data indicating a plurality of amounts of current, each amount of current associated with a corresponding applied load
determining, by the processor, a magnitude of a load applied to the vibrotactile actuator based on the calculated amount of current and the current-load correspondence data.

20. The method of claim 19, further comprising:
determining, by the processor, whether the calculated amount of current is greater than or equal to a threshold amount of current; and
outputting, by the processor, one or more haptic feedback signals to the vibrotactile actuator in response to the calculated amount of current being greater than or equal to the threshold amount of current.
